(19) United States
(12) Patent Application Publication
(10) Pub. No.: US 2018/0138494 A1
(43) Pub. Date: May 17, 2018

(54) KINETIC BATTERIES

(71) Applicant: Worcester Polytechnic Institute, Worcester, MA (US)

(72) Inventors: Aaron M. Birt, Worcester, MA (US); Diran Apelian, Boylston, MA (US)

(21) Appl. No.: 15/814,781

(22) Filed: Nov. 16, 2017

Related U.S. Application Data
(60) Provisional application No. 62/423,237, filed on Nov. 17, 2016.
(60) Provisional application No. 62/550,846, filed on Aug. 28, 2017.

(51) Int. Cl. H01M 4/04; H01M 4/62; H01M 4/525; H01M 4/587; C23C 24/04; C23C 24/06; H01M 4/505; H01M 4/485; H01M 4/58; H01M 4/38; H01M 4/40

(52) U.S. Cl. CPC H01M 4/0419; H01M 4/625; H01M 4/525; H01M 4/587; C23C 24/045; C23C 24/06; H01M 4/387; H01M 4/505; H01M 4/485; H01M 4/5825; H01M 4/382; H01M 4/405; H01M 4/626

(57) ABSTRACT

A rechargeable lithium-ion (Li-ion) battery employs a solvent-less, low temperature approach to battery manufacturing that forms charge material from kinetic energy of high velocity particles impelled into an aggregation such that bombardment of the particles against other particles in the aggregation forms a charge conveying structure. High velocity bombardment from a carrier gas nozzle accumulates an active charge material (active material) and metal binder in a layered arrangement for the finished battery. Preparation of the particles, such as by ball milling or freeze drying, arranges particle agglomerations. The particle agglomerations, when impelled against other agglomerations or a current collector, forms a layer of cathodic, anodic or electrolytic battery material. The metallic binder conveys charge for mitigating or eliminating a need for a planar current collector underlying the sprayed layer. The resulting layers are suitable for battery operation, and are manufactured in an absence of any solvent drying or disposal.

### RELATED APPLICATIONS

This application claims the benefit under 35 U.S.C. § 119(e) of U.S. Provisional Patent Application No. 62/423,237, filed Nov. 17, 2016, entitled “KINETIC BATTERIES,” and U.S. Provisional Patent Application No. 62/550,846, filed Aug. 28, 2017, entitled “SPRAYED LAYER BATTERY CONSTRUCTION,” both incorporated herein by reference in entirety.

### BACKGROUND

Rechargeable batteries, such as lithium ion batteries are manufactured by spreading, rolling, and drying a slurry of conductive polymer binder, toxic solvent, conductive agent, and lithium-based oxide (or other ceramic) particles onto a conductive current collector to form a functional cathode. This limits the size, geometry, and energetic properties of the resulting batteries. The prevailing conventional method for electrode production, known as tape casting, depends on mixing a slurry of at least four ingredients, spreading the mixture across the current collector using a Doctor blade, calendaring the coating to control surface finish, and then baking out the solvent to induce porosity.

### SUMMARY

A rechargeable lithium-ion (Li-ion) battery employs a solvent-less, low temperature approach to battery manufacturing that forms charge material from kinetic energy of high velocity particles impelled into an aggregation such that bombardment of the particles against other particles in the aggregation forms a charge conveying structure. High velocity bombardment from a carrier gas nozzle accumulates an active charge material (active material) and metal binder in a layered arrangement for the finished battery. This metal binder serves as the structural binding agent, the electron conducting agent, and the deformation phase critical for cohesion of the sprayed agglomerate particles. Preparation of the particles, such as by ball milling or freeze drying, arranges particle agglomerations. The particle agglomerations, when impelled against other agglomerations or a current collector, forms a layer of cathodic, anodic or electrolytic battery material. The metallic binder conveys charge for mitigating or eliminating a need for a planar current collector underlying the sprayed layer. The resulting layers are suitable for battery operation, and are manufactured in an absence of any solvent drying or disposal.

Configurations herein are based, in part, on the observation that lithium ion batteries are achieving widespread popularity for mobile power needs of electric vehicles and personal devices. Rechargeable power supplies such as lithium ion batteries are generally sought for their high energy density and their ability to deliver current at a high rate. Unfortunately, conventional approaches to battery manufacturing suffer from the shortcoming of solvent based approaches that impose toxicity and environmental concerns for use, handling and disposal of the solvent. Accordingly, configurations herein substantially overcome the toxicity and handling shortcomings by providing a spray based manufacturing method that forms cathode, anode and electrolyte layers from high velocity particle spraying that forces the charge materials into a conformant arrangement conducive to charge generation and transport. Further, the flexibility of particle spray deposition to electrode fabrication allows architecture of non-standard battery geometries to suit implementation specific volume or electrochemical constraints.

A particle stream of precision milled particles engages and accumulates the particles into a distribution suitable for battery operation, as successive particles are forced together in a binding arrangement sufficient for charge transport. Spraying, as employed herein, refers to impelling or forcing the particle agglomerations though a nozzle using a pressurized carrier gas such that they bombard an accumulation surface and build a thickness as bombarded by successive agglomerations due to deformation and ductility of the agglomerations. In contrast to conventional uses of cold spray, the particle preparation forms agglomerations that, in conjunction with impelling from the nozzle, aggregate based on the ductile nature of the agglomerations into a density suitable for battery usage. In this manner, a layer of charge materials may be deposited onto a current collector for subsequent rolling, folding, or layering for a finished battery, or multiple layers defining cathode, anode and electrolyte regions may be continuously sprayed as a complete structure without a need for a conductive current collector. Each layer of either cathode, anode, or electrolyte region may be controlled for composition, porosity, and geometry by altering the powder feedstock and spray conditions. Doing so allows for customization of the charge/discharge profiles of the battery cell.

The disclosed approach presents a solvent-less approach to battery manufacturing in which the core constituents are a powdered material. The process takes an active material blended with a metal binder and sprays the material at supersonic speeds onto a current collector. Additional additives such as carbon black, stearic acid, or a solid electrolyte may be blended with the powder and sprayed for varying benefits. The end result is a battery electrode produced at lower costs, with greater control over the battery internal geometry and overall thickness. This enables higher capacity batteries, and batteries that can operate at higher charge/discharge rates with reduced overall heating. Alternate configurations include multiple layer sprays for forming respective cathode, electrolyte and anode layers, and an absence of an underlying current collector achieved by dispersing conductive particles in the sprayed material.

In one configuration, the kinetically formed batteries (kinetic batteries) may employ solid state manufacturing such as cold spray to bind lithium oxide or phosphate particles with a metallic phase to create the cathode. This approach decreases interface resistances, enables local control of energetic properties, and allows for manufacture of custom-sized cathodes without the inactive materials such as binders and toxic solvents used in traditional manufacturing.

Other approaches may eliminate the planer current collector, typically a copper or aluminum sheet, and deposit multiple layers in succession for cathode, electrolyte and anode layers in one pass from multiple nozzle rows. Degrading or disintegrating polymers may be incorporated to assist particle flow and adhesion.

Battery components, such as the cathode and anode layers, are constructed via an additive manufacturing technique that can consolidate these materials in the solid state. The cold spray process accelerates particulate matter to supersonic speeds through a converging-diverging nozzle using a high temperature, high pressure carrier gas. At these accelerated speeds it is possible to create conformal contact between ductile-ductile or ductile-ceramic materials through extreme deformation along the particle boundaries. It has been shown in many cases that a small fraction of ductile metallic binder can be used to deposit non-deformable ceramic particles onto a metal substrate. For example, deposition of Al₂O₃ with aluminum has been found to optimize certain properties at around 15% Al₂O₃, however deposition occurs as high as 75%.

In further detail, the method of forming a battery using sprayed battery construction as disclosed herein includes agitating particles to form particulate agglomerates adapted for cold spray deposition. The agglomerate includes cathode material for a battery defined by conductive particles and charge material particles. Anode material and a separator layer of electrolyte may also be formed. A nozzle sprays the agitated particulate mixture into a layered structure configured to define at least a portion of the battery by accelerating the particulate mixture for conformal communication between the particles in the particulate mixture to promote charge flow. Therefore, the particles are impelled and bombarded in such a manner that they deform slightly into a density suitable for ionic communication and transportation of electrical energy (electrons).

A corresponding apparatus for forming the sprayed, or additive, battery includes an agitator for agitating particle feedstock to form agglomerations of feedstock for the battery, and a hopper for storing a particulate mixture resulting from agitating the feedstock. A carrier gas propels the particulate mixture through a vessel, and a shaped nozzle receives the propelled, particulate mixture and impels the particulate mixture for conformal communication between the particles in the particulate mixture resulting from bombardment of the agglomerated particles to promote subsequent charge flow once manufactured into a battery.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context view of a battery layers;

FIG. 2 shows a spray nozzle for forming a battery layer;

FIG. 3 shows a flow diagram of particles impelled by the nozzle of FIG. 2;

FIGS. 4a-4c show particles used for feedstock in the flow of FIG. 3; and

FIG. 5 shows multiple layer fabrication of the layers in FIGS. 2-4c.

### DETAILED DESCRIPTION

Configurations below depict an example of battery construction. Construction employs sprayed particulate matter, such as high pressure cold spray, low pressure cold spray, laser assisted cold spray or similar additive manufacturing technique. In contrast to conventional solvent based approaches, using a slurry of charge material and binder liquids followed by evaporation, the active material is sprayed with a conductive metal binder and optional solid electrolyte polymer powder to form a proper density from the spray velocity.

Formation of the battery structure may include depositing either a cathodic or anodic active material onto a current collector, or a “collector-less” arrangement which forms a cathode, electrolyte and anode layer in succession and in the absence of a current collector.

The first configurations overcome conventional shortcomings of solvent based polymeric binders by combining a cathode material and a metallic binder to form a powdered combination, and spraying the powdered combination onto a current collector. Spraying includes a cold spray process operable for iterative spraying of the powdered combination for forming a multi-layer thickness of the powdered combination on the current collector. The metallic binder includes a single phase high purity aluminum alloy, and the powdered combination may be devoid of a polymeric binder for avoiding conventional solvents and drying/evaporation. The resulting layered current collector is formed into a battery of suitable size and dimensions.

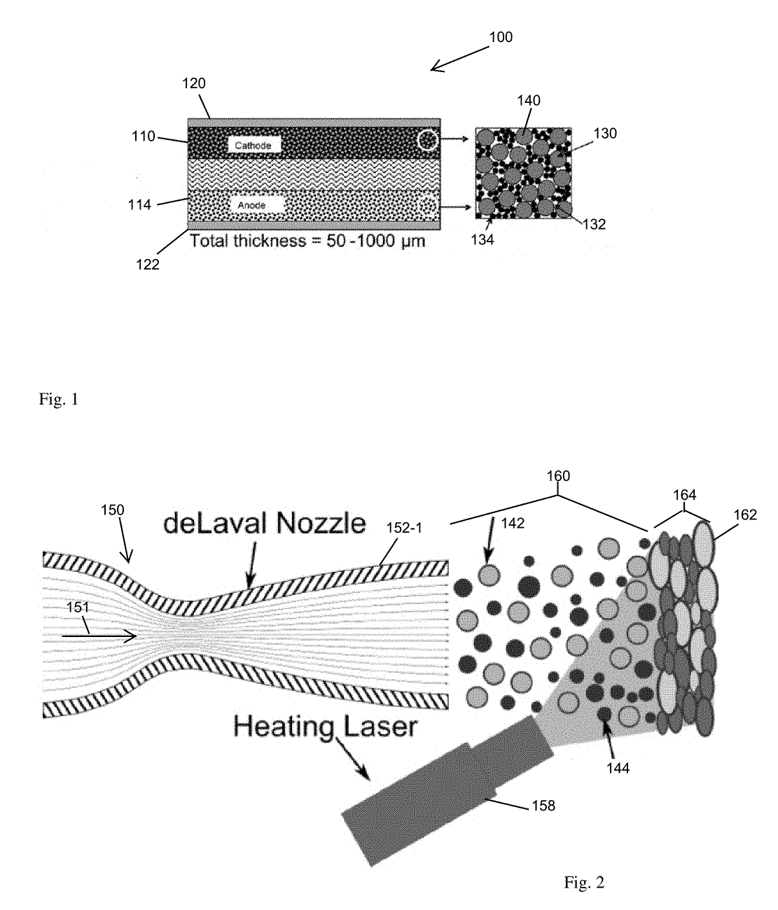

FIG. 1 is a context view of a battery layers. In a layered structure 100, a cathode layer 110, electrolyte layer 112 and anode layer 114 are disposed between opposed current collectors for a cathode 120 and anode current collectors 122. The cathode 110 and anode 114 layers define a particle network 130. Conventional batteries employ a solvent derived arrangement to disperse active material 140 with binder 132 and conductive material 134. The disclosed approach forms a layer from high velocity (e.g. supersonic) particles sprayed to bombard other particles and form the particle network 130, rather than mixing and layering using volatile and/or toxic solvents.

FIG. 2 shows a spray nozzle for forming battery layers 110, 112, 114. Referring to FIG. 2, a nozzle 150 defined by a fluid conduit employs a carrier gas 151 for directing and impelling a particle stream 160 into a bombarded arrangement defining a layer 164. The particle stream 160 has high velocity such that the individual particles are slightly deformed 162 upon bombardment, based on ductility. The particles include at least a conductive metal binder 142 and charge material 144. Optional use of a heat laser 158 may heat the impelled, layered mixture, or an appropriate heating may be applied to the feedstock prior to nozzle 150 passage.

In contrast to the precisely controlled atmosphere and concentrations needed in tape casting, the disclosed kinetic batteries employ only two components: cathode powder and metallic binder. LiFePO₄ (LFP) was selected as one cathode material of choice due to its low cost and high levels of safety, however any active chemistry for either the anode or cathode can be easily substituted for LFP. Rather than using a slurry with a polymer, solvent, plasticizer, etc., a single phase high purity aluminum alloy defines the metallic binder. The cathode powder with approximate size range of 0.1-15 micrometers will be ball milled with the high purity aluminum powder to produce “snowballs” that will be cold sprayed onto a high purity aluminum substrate. Aluminum tends to be a highly ductile material that cold sprays readily, especially in unalloyed form.

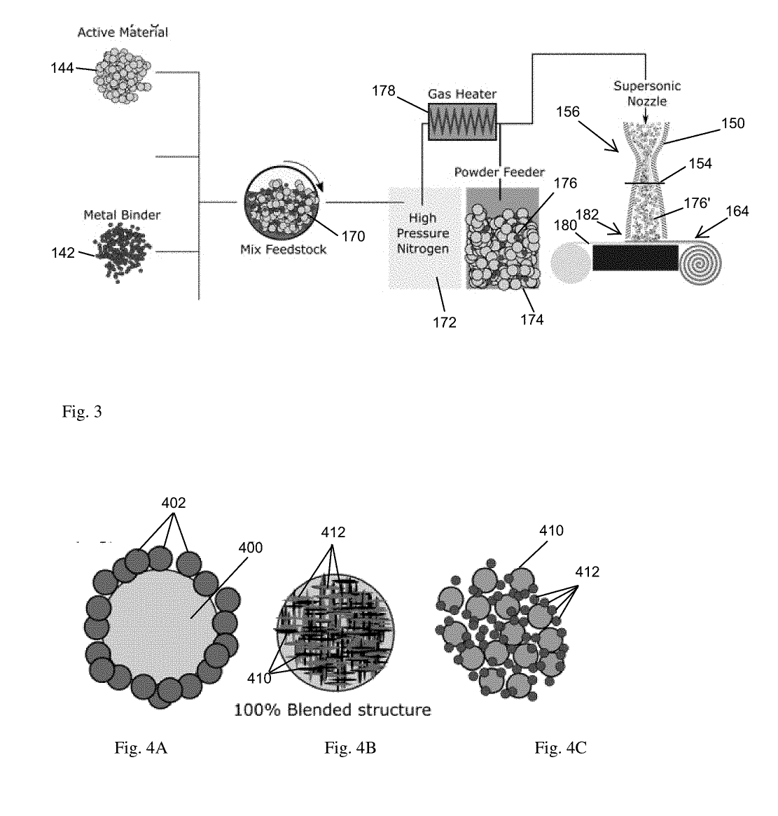

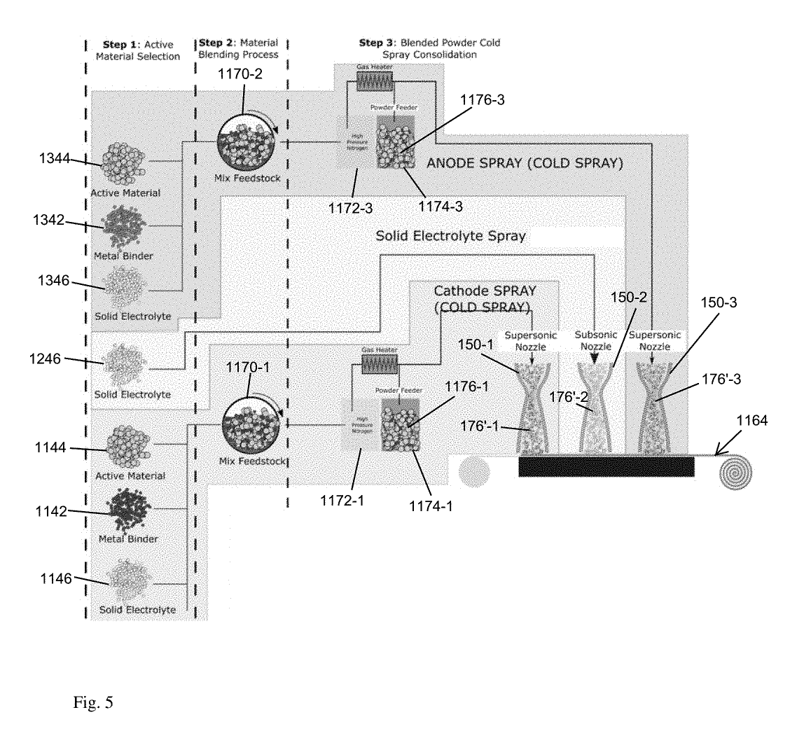

FIG. 3 shows a flow diagram of particles impelled by the nozzle of FIG. 2. Referring to FIGS. 1-3, the active material (either cathode or anode) 144 and the metal binder 142. The metal binder 142 performs similarly to the binder, electrolyte and optionally, the current collector in conventional approaches by fixing the charge material in a configuration for electron transport to generate a current flow. The metal binder 142 and active material 144 combine in a particle mixture suitable for forming a sprayed battery. An agitator 170 for ball milling is employed for agitating the particles into an agglomerated particulate mixture adapted for cold spray deposition, in which the particulate mixture defines cathode material for a battery by including conductive particles and charge material particles. Alternate treatment for preparing the particulate mixture may also be performed, discussed below with respect to FIGS. 4A-4C. In general, agitating refers to creating a feedstock including a plurality of agglomerations, such that each agglomeration includes at least conductive particles and charge material. Any suitable milling, grinding or physical manipulations of the particle feedstock may be employed. The agglomerations, or clusters of the particles in the particulate mixture 176, allow for a density conducive to charge storage and production once propelled into the layered arrangement 164. A properly milled or agitated metal used for the conductive particles is beneficial because it can serve as both the binding and conducting agent within one structure, and therefore provide properties of conventional binders and current collectors.

The particle mixture 176 passes to a powder feeder 174 such as a hopper, where a carrier gas such as high pressure nitrogen 172 is employed for spraying the agitated particulate mixture 176 into a layered structure or arrangement 164 configured to define at least a portion of the battery. A heater 178 adjusts a temperate of the carrier gas to an optimal level for particle deposition, as an alternative or in conjunction with laser heating as in FIG. 2. Each particulate (particle) mixture 176 is suited for either a cathode, anode or electrolyte layer by accelerating the particulate mixture for conformal communication between the particles in the particulate mixture 176 to promote charge flow. Particles of electrolytic materials (electrolyte) may be mixed with the cathodic and anodic mixtures, and also for defining the electrolyte layer between them. Solid electrolytes having suitable ductility for the high velocity spraying include solid ceramic and solid polymer electrolytes. It should be noted that in the case of the electrolyte layer formation, discussed further below, a charge material is not needed.

The nozzle 150 includes an apparatus for connecting the pressurized carrier gas supply to the shaped nozzle 150 and has a flow directed towards the accumulative layered structure (arrangement) 164. In order to achieve the particle velocity for bombardment into the conformant, slightly deformed shape conducive to charge flow, the shaped nozzle 150 has a substantially round cross section 154 with a reduced diameter 156 along a central portion of its length and adapted for converting heat energy of the flow into kinetic energy. Alternative nozzle shapes, such as square nozzles, may also be employed. The nozzle 150 focuses and directs the carrier gas propelled particle mixture 176′ into the layered arrangement 164 by accelerating the particles to a velocity that, when impelled against the current collector or accumulation surface, respond based on ductility. Such nozzles are capable of achieving supersonic speed by the carrier gas for causing ductile contact between the sprayed particles; alternatively, lower subsonic velocities may be employed. The arrangement of the particles is such that contact is suitable for ionic transfer supporting charge flow, such as metallurgical or intimate contact.

In the example configuration, the nozzle 150 depicts cold spray. Cold spray is a process typically used to deposit ductile metals onto a substrate. In many conventional cases, the substrate is a worn out legacy component that can be repaired via cold spray, or otherwise must be replaced. The unique capability of cold spray is that it uses a small amount of heat to consolidate materials, and instead relies on high amounts of kinetic energy. This allows materials, both powder and substrate, to remain well below any oxidation or melting temperatures. The result is a process that can deposit with very high efficiencies, with a wide range of materials and material combinations that could otherwise react negatively.

The same processing benefits can be applied to blends of materials, such as ceramics and metallic (cermets) as are disclosed herein. Cold spray may also be employed to deposit polymeric materials in addition to metallic, ceramic, and cermet materials.

In cold spray, there is a limitation on the size of powders that may be sprayed. The typical range is from 25 to 45 μm. This is due to a fundamental limit in the spray process where below a certain impact temperature and velocity (called the critical velocity) materials won't adhere. Small particles are unable to carry their momentum across the fluid dynamic boundary layer on the surface of the substrate and thus never exceed the critical velocity. Note this presupposes, as with typical cold spray processing, that the particles are below their melting temperature.

Several considerations are relevant to the gas impelled, bombardment of dry particles for forming charge material. These considerations are resolved by several parameters, including nozzle velocity, nozzle angle and size, and particle size, as well as the actual composition of the particle mixture. Batteries rely on maximum surface area for the active materials in order to function effectively. This means that the ideal electrode has active material particles that are very small. This would naturally tend to disqualify them from being sprayable by conventional methods. However, by blending the active material particles (typically a ceramic structure—oxide, phosphate, salt, graphite, perovskite, spinel, etc.) with a ductile metallic powder (such as aluminum, copper, tin, titanium, steel, nickel, tantalum, tungsten, lithium) or metal powder alloys of the same such that each particle is a combination of both active material and binder material, then the resulting agglomerated particle meets the criteria both for size and for presence of a ductile phase. This requires that both phases remain in their original chemical state, but be bound together mechanically, via Van der Waals forces, electrostatic forces, or chemical bonds by an additional compound.

In the example arrangement of FIG. 3, the nozzle 150 sprays the particulate mixture 176 onto a conductive planar surface such as a current collector 180 for building the accumulative layered structure. The construction of the nozzle and gas allows for spraying the particle mixture 176 based on a set of predetermined parameters for defining a flow rate of the particle mixture, a pressure of the carrier gas and a standoff distance 182 of an exit of the nozzle to an accumulative layered structure.

The approach of FIG. 3 depicts a single nozzle, which may be rastered back and forth across a surface multiple times, to produce the layers 110, 112, 114, or electrodes. Alternate configurations, discussed below with respect to FIG. 5, employ a large array of nozzles would be used to produce electrodes on a roll-to-roll manufacturing line. The blended or agitated particle mixtures are placed in a powder feeder and carried into the spray lines via a gas stream. As the powders enter the nozzle, they are accelerated to high speeds (supersonic speeds if above the critical pressure). After acceleration, the particles impact onto the appropriate current collector for anode or cathode to directly form the electrode with no post process heating or calendaring. Different parameters affect the resulting layered structure 164, including the following:
Powder flow rate (1-200 grams/minute)
Gas Temperature (25-600° C.)
Gas Pressure (50 to 700 PSI)
Note that below roughly 120 PSI is subsonic, low pressure cold spray
Above 120 PSI is supersonic, high pressure cold spray
Nozzle Geometry (Choke Diameter, Expansion Ratio, Exit Length—all critical and customized depending on specific needs)
Nozzle material (WC, Stainless Steel, Polymeric, SiC)
Standoff Distance—distance from nozzle exit to surface (10-100 mm)
Raster speed—the speed at which the nozzle moves relative to the surface or vice versa (5 mm/s to 1000 mm/s)
Index Step—the amount of overlap between lines of spray. Note this could also be considered the overlap between nozzles in an array of nozzles. This varies depending on the nozzle configuration.
Substrate type (Aluminum or copper depending on the anode vs cathode—ranging from 5 μm to 400 μm)
Gas Type (Nitrogen, Helium, or air)
Atmosphere (ideally should be inert based on the gas into the spray chamber)
Substrate and particle temperatures (can be preheated to various temperatures depending on final battery properties)

FIGS. 4A-4C show preparation of particles used for the particle mixtures 176 in the powder feeder 174 in the flow of FIG. 3. Referring to FIGS. 3 and 4A-4C, agglomerations of particles defined by the feedstock processing result in the particle density and conformal arrangement from bombardment upon nozzle 150 exit.

FIG. 4A shows an aluminum core 400 surrounded by particles 402 of active material, created by spray drying, freeze drying, or electrocoating. Agitation may therefore include creating a feedstock including conductive particles circumferentially surrounded by the charge material particles. Agitating may also include ball milling for generating a uniform mixture of the particles. FIG. 4B shows a uniform blended mixture of LFP 410 and aluminum 412 produced by ball milling. FIG. 4C shows agglomerations of aluminum 420 adhering together with active material 412 in a “snowball” texture of feedstock particle mixture 176, which can be produced by spray dry agglomeration or freeze drying. Any of the mixtures in FIGS. 4A-4C may also include a solid electrolyte powder in the agitated particles, for spraying with the agitated mixture. The conductive particles generally include materials such as Al, Cu, Sn and C which are conductive and amenable to powder formations.

In the example of FIG. 4B, planetary ball milling is a lab-scale method of mechanically mixing materials together. In this process, the materials to be mixed are placed in a jar with a quantity of balls. The jar is then rotated about a central axis, and its own axis simultaneously. This results in a machine wherein the large balls can impact the materials thus blending them together in a uniform and spherical fashion. Notable parameters for particle mixture 176 include:
Rotational Speed (100-700 RPM)
Blended Material Composition (active material, metal binder, additive)
   5-50% metal binder (Can be any aluminum, copper, tantalum, tin, nickel, lithium, cobalt, vanadium, or iron based alloy or pure material)
   0-40% additive (graphite, carbon black, solid electrolyte, solid polymer electrolyte, stearic acid, paraffin wax, etc.)
   Remainder active material (LiNiCoAlO₂ (NCA), LiNiMnCoO₂ (NMC), LiNi₅Co₃Mn₂O₂ (Hi-NMC), LiFePO₄ (LFP), LiCoO₂ (LCO), LiMn₂O₄ (LMO), Li₄Ti₅O₁₂ (LTO), Graphite, Silicon, Li-Sulfur, Lithium metal, tin, or a mixture of active materials)
Volume of the jar filled (5-65%)
Ball to Material Blend Volume Ratio (1:20 to 30:1)
Size of balls used (1 mm to 20 mm)
Jar and ball materials used (Al2O3, Stainless Steel, Tungsten Carbide, Silicon Carbide)
Cooling/Heating of the jars (Cooling to liquid nitrogen, heating to 300° C.)
Pre- or Post-processing of materials (fluidized separation, sieving based on particle size or morphology)
Jar atmosphere (inert-Argon/Nitrogen/Helium, Air)

Referring to the structures of FIGS. 4A and 4C, spray agglomeration is a process whereby powders to be agglomerated are suspended and dispersed in a liquid medium, typically with a combination of solvent, dispersant, and binder. These materials are injected into a nozzle and atomized via a pressurized gas stream. As the solvent and dispersant evaporate from a droplet, the polymer binder agglomerates together all of the phases of interest. In the case of electrode materials, a small amount of polymer binder could be used to bind the metal binder to the active material. This is another way to produce agglomerated ‘granules’ that are large enough to spray, have fine active constituents, and maintain the appropriate chemical phase. In contrast to conventional approaches, the liquids employed for particle mixture preparation disintegrate or decompose prior to deposition for forming the layered structure 164, and therefore continue to avoid the solvent drying and disposal shortcomings of conventional approaches.

FIG. 5 shows multiple layer fabrication of the layers in FIGS. 2-4c. The arrangement of FIGS. 2-4c, depicting a cathode material arrangement, may also be employed for anode material. Further, a complete battery cell requires a cathode layer, and anode layer, and an electrolyte or separator between them to allow for ionic transfer to balance the current flow for battery use (discharge) or charging. A plurality of nozzles may be arranged to deposit particle mixtures for cathode material 176′-1, electrolyte layers 176′-2 and anode layers 176′-3 (176′ generally).

Referring to FIGS. 3 and 5, an apparatus including a plurality of nozzles 150 and corresponding hoppers for particle mixtures 176 manufactures a complete battery structure, including cathode, electrolyte and anode layers. The resulting approach forms cathode, electrolyte and anode layers by iteratively spraying additional agitated, particulate mixtures to define a cumulative layered structure 1164 having electrical characteristics of the battery. The nozzles 150-1 . . . 150-3 are adapted for spraying from rows of nozzles defining each of the cathode, electrolyte and anode layers in sequence for a predetermined thickness of a suitable width. Particle mixtures 176 are based on generating the particulate mixture in separate hoppers 1174-1, 1174-3 corresponding to each layer of the layered structure 1164. This may include agitating the particles with a liquid for forming agglomerations in the particle mixture, such that the liquid disintegrates or decomposes prior to deposition. evaporating or disintegrating spray. A cathode material is formed from a metal binder 1142 and an active charge material 1144, as in the single nozzle approach of FIG. 3. An additional solid electrolyte 1146 may also be added. The resulting particle mixture 1176-1 and carrier gas 1172-1 combine to form sprayed mixture 176′-1 from nozzle 150-1. The cathode material forms a bottom layer of the layered structure 1164. Carrier gas 1172-1, 1172-3 provide proper impelling and bombardment velocity for the cathode and anode, respectively. A current collector may be employed, or the conductive nature of the binder, optionally with embedded wires or conductive strands, may replace the current collector.

A solid electrolyte powder 1246 defines the electrolyte or separator layer, and is a uniform composition which may not need particle processing. The sprayed electrolyte mixture 176′-2 is deposited as a second layer on the layered structure 1164 from nozzle 150-2.

An anodic active material 1344 combines with a metal binder 1342 and a solid electrolyte 1346 as the feedstock particle mixture 1176-3 for the hopper 1174-3. Nozzle 150-3 is used for sprayed mixture 176′-3 onto the top layer of the structure 1164 forming the anode.

In various configurations, the particulate mixtures include the agglomerations may be formed from ingredients including a metal binder (aluminum, copper, tantalum, tin, nickel, lithium, cobalt, or iron based alloy or pure material), an additive (graphite, carbon black, solid electrolyte, solid ceramic electrolyte, solid polymer electrolyte, stearic acid, paraffin wax, etc.), and an active material (LiNiCoAlO₂ (NCA), LiNiMnCoO₂ (NMC), LiNi₅Co₃Mn₂O₂(Hi-NMC), LiFePO₄ (LFP), LiCoO₂ (LCO), LiMn₂O₄ (LMO), Li₄Ti₅O₁₂ (LTO), Graphite, Silicon, Li-Sulfur, Lithium metal, tin, or a mixture of active materials).

Other spray processes include any method that deposits material via a process in which a blend of active material and metallic binder (plus optional additives) are consolidated onto a current collector or similar structure. This would include low pressure cold spray, high pressure cold spray, warm spray (where a thermal spray process is cooled via a gas so that particles are impacted below melting conditions), detonation cladding, electrostatic spray and others. Any suitable process which can deposit the agglomerated particles in a layered structure, including 3D printers and additive manufacturing techniques, may be employed.

The materials, nozzle parameters and milling parameters discussed above may be implemented in a variety of configurations to achieve desired battery characteristics. Several example configurations are depicted in the tables below, however other arrangements may of course be employed. These examples are not intended as a definitive or limiting usage of the disclosed approach, but rather merely of an example of the interrelations between the parameters discussed above.

One of the features of cold spray as disclosed herein is a ‘critical velocity window,’ which defines a combination of velocity and temperature outside of which a material will not adequately deposit via the kinetic deformation mechanisms. This requires powder particles to be in a specific size range so that they can carry sufficient momentum after exiting the nozzle to deform upon impact. However, battery materials require that the active material portion have a maximum surface area, which typically necessitates fine particles. Many conventional approaches employ spraying active materials independent of any binding agent with success only as a single layer of deposition. Powders in the disclosed approach benefit from the feature that each particle is an agglomeration of a metal binding agent and fine active materials. An example of this agglomeration technique via ball milling is disclosed below.

A particular configuration was performed using a 50/50 split of active material and metal binder. However, it was found that because of the larger volume fraction of aluminum powder this resulted in a disproportionate amount of aluminum. Thus, it was determined that the active material loading conditions could be significantly enhanced.

In a successive iteration, the metal binder concentration was reduced to 22% of the total mass, and was milled with methanol as a slurrying agent. This resulted in much more evenly distributed amounts of aluminum in the powder, but with much larger than desired particles. In this sample, powders were on the order of 100-200 μm instead of the desired 20-45.

Maintaining the metal binder fraction at approximately 22%, eliminating the methanol slurry, and reducing the ball milling size to 5 mm resulted in a significant reduction in the average particle sizes. While some particles were still on the order of 100 μm, many more were in the 10-20 μm range.

In order to avoid nozzle clogging, powder uniformity may be beneficial. This may involve the use of additives such as carbon black, or operation of the mill at precise loading conditions to produce highly uniform powders. In either scenario, the final step must be to sieve the powders into the final desired size range. Improved performance results from a ball mill that rotates in a vertical plane, rather than a horizontal plane. Stainless steel milling media became the material of choice. Table I depicts particular agitation parameters.

TABLE I

| Method Used | Vertical Planetary Ball Mill |
|---|---|
| Jar Material | Stainless Steel |
| Ball Material | Stainless Steel |
| Ball Size (mm) | 15 mm |
| Active Material | LiFePO₄ |
| Metal Binder | Aluminum 99.9% |
| Additive | NA |
| Mass Fraction Active (%) | 20% |
| Mass Fraction Metal (%) | 80% |
| Additive Mass Fraction (%) | 0 |
| Ball to Powder Mass Ratio (:) | 11:1 |
| Rotational Speed (RPM) | 400 RPM |
| Milling Time (Minutes) | 450 |

The method of agglomerating a powder and spraying it via cold spray onto the current collector has been used to form a thin (˜10 μm thick) cathode. This demonstrates that the method is practical and forms a functional battery. However, it also shows that the specific capacity is lower than the theoretical limit (170 mAh/g) of standard LFP. This is largely due to inconsistencies in the active material measurements at the external test facility.

A notable feature in the production of these powders is the rotational speed and the size of the balls used in the processing, as depicted in table II below

TABLE II

| Method Used | Horizontal Planetary Ball Mill |
|---|---|
| Jar Material | Al₂O₃ |
| Ball Material | Al₂O₃ |
| Ball Size (mm) | 5 mm |
| Active Material | LiFePO₄ |
| Metal Binder | Aluminum 99.9% |
| Additive | Carbon Black |
| Mass Fraction Active (%) | 68% |
| Mass Fraction Metal (%) | 19% |
| Additive Mass Fraction (%) | 13% |
| Ball to Powder Mass Ratio (:) | 8:1 |
| Rotational Speed (RPM) | 600 RPM |
| Milling Time (Minutes) | 180 |

A range of spray parameters were tested on this powder. Gas temperatures as low as 100° C. were evaluated and found to produce minimal deposition. After several iterations, it was determined that a longer standoff distance (50 mm) and slow raster speed (20 mm/s) enabled the deposition of a thin layer of cathode material, as shown in Table III.

TABLE III

| | |
|---|---|
| Gas Used | Nitrogen |
| Gas Temperature | 400° C. |
| Gas Pressure | 435 PSI |
| Powder Used | 68% LFP, 19% Al, 13% Carbon Black |
| Substrate Used | Al Foil |
| Powder Feed Rate (RPM) | 6 RPM |
| Standoff Distance (mm) | 35 |
| Raster Speed (mm/s) | 20 |
| Electrode Thickness | 10 μm |

It is a significant feature that cathodes of varying thickness be produced via the disclosed process. To that end, three different powders containing approximately 10, 20, and 30% metal binder content by mass were produced. These powders contained no additives, and were produced using a different, newly optimized set of milling conditions that provided a maximum dispersion of metal binder within the active material matrix. These three different powders were each used to consolidate electrode sheets of three different thicknesses—nominally 30, 80, and 150 μm respectively. A series of spray processing conditions was evaluated where raster speed, gas temperature, and powder feeder rate were all altered until finding an ideal set of deposition conditions for this powder set. To produce thicker electrodes, multi-layer buildups are used until the desired thickness is reached.

In a particular configuration, depicting a 10% Aluminum, 30 μm thick electrode, the 10% aluminum binder powder and electrode demonstrated the process capabilities at low binder fractions. The powder is uniform and results in a thin electrode coating on the order of 25-40 μm. Agitation parameters are detailed in Table IV.

TABLE IV

| Method Used | Vertical Planetary Ball Mill |
|---|---|
| Jar Material | Stainless Steel |
| Ball Material | Stainless Steel |
| Ball Size (mm) | 15 mm |
| Active Material | LiFePO₄ |
| Metal Binder | Aluminum 99.9% |
| Additive | NA |
| Mass Fraction Active (%) | 10% |
| Mass Fraction Metal (%) | 90% |
| Additive Mass Fraction (%) | 0 |
| Ball to Powder Mass Ratio (:) | 12:1 |
| Rotational Speed (RPM) | 400 RPM |
| Milling Time (Minutes) | 450 |

Spray consolidation conditions were adjusted several times before determining an optimal process recipe. For this sample, a single layer was produced by rastering across the foil surface several times. Each raster line was overlapped by 1 mm. Surface uniformity may be improved by adjusting that raster overlap or by altering the spray angle to induce a greater amount of shear deformation upon impact, and is depicted in Table V.

TABLE V

| | |
|---|---|
| Gas Used | Nitrogen |
| Gas Temperature | 410° C. |
| Gas Pressure | 600 PSI |
| Powder Used | 10% Al, 90% LFP |
| Substrate Used | Al Foil |
| Powder Feed Rate (RPM) | 12 RPM |
| Standoff Distance (mm) | 35 |
| Raster Speed (mm/s) | 300 |
| Electrode Thickness | 25-40 μm |

A thicker electrode produced with approximately 20% aluminum binder by weight was also produced, using the powder processing of Table VI. This electrode was deposited to between 50 and 60 μm. While the extra binder content is not critical for deposition of thicker electrode materials, it provides greater flexibility in the spray processing parameters, shown in Table VII.

TABLE VI

| Method Used | Vertical Planetary Ball Mill |
|---|---|
| Jar Material | Stainless Steel |
| Ball Material | Stainless Steel |
| Ball Size (mm) | 15 mm |
| Active Material | LiFePO₄ |
| Metal Binder | Aluminum 99.9% |
| Additive | NA |
| Mass Fraction Active (%) | 20% |
| Mass Fraction Metal (%) | 80% |
| Additive Mass Fraction (%) | 0 |
| Ball to Powder Mass Ratio (:) | 11:1 |
| Rotational Speed (RPM) | 400 RPM |
| Milling Time (Minutes) | 450 |

TABLE VII

| | |
|---|---|
| Gas Used | Nitrogen |
| Gas Temperature | 410° C. |
| Gas Pressure | 600 PSI |
| Powder Used | 20% Al, 80% LFP |
| Substrate Used | Al Foil |
| Powder Feed Rate (RPM) | 12 RPM |
| Standoff Distance (mm) | 35 |
| Raster Speed (mm/s) | 300 |
| Electrode Thickness | 50-60 μm |

While the structure of most tape-cast batteries includes significant void porosity, the disclosed electrodes provide a fine distribution of microporosity throughout the coating, which enables electrolyte penetration and lithium-ion conduction.

Anode powders containing graphite and copper have also been produced. Two different powders are shown below in TABLE VIII and IX to highlight the interaction of ball size relative to the final powder morphology. Note that due to the high density of copper relative to graphite, there is a significantly larger mass fraction of copper binder, but an equivalent volume fraction to the cathode work performed. In the first powder below, long tendrils have copper have been produced in a matrix of graphite powder. This was done with large, 15 mm stainless steel balls. The second powder in Table IX was produced using smaller, 10 mm balls. While the overall agglomerate size is smaller, there is also less deformation and blending of the copper phase in the graphite. By increasing the rotational speed or milling time, it is possible to achieve greater homogeneity.

TABLE VIII

| Method Used | Vertical Planetary Ball Mill |
|---|---|
| Jar Material | Stainless Steel |
| Ball Material | Stainless Steel |
| Ball Size (mm) | 15 mm |
| Active Material | Artificial Graphite |
| Metal Binder | Copper 99% |
| Additive | NA |
| Mass Fraction Active (%) | 48% |
| Mass Fraction Metal (%) | 52% |
| Additive Mass Fraction (%) | 0 |
| Ball to Powder Mass Ratio (:) | 10:1 |
| Rotational Speed (RPM) | 400 RPM |
| Milling Time (Minutes) | 450 |

TABLE IX

| Method Used | Vertical Planetary Ball Mill |
|---|---|
| Jar Material | Stainless Steel |
| Ball Material | Stainless Steel |
| Ball Size (mm) | 10 mm |
| Active Material | Artificial Graphite |
| Metal Binder | Copper 99% |
| Additive | NA |
| Mass Fraction Active (%) | 48% |
| Mass Fraction Metal (%) | 52% |
| Additive Mass Fraction (%) | 0 |
| Ball to Powder Mass Ratio (:) | 10:1 |
| Rotational Speed (RPM) | 400 RPM |
| Milling Time (Minutes) | 450 |

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of forming a sprayed battery construction, comprising:
agitating particles in a particulate mixture adapted for cold spray deposition, the particulate mixture including active material for a battery, the particulate mixture including conductive particles and charge material particles; and
spraying the agitated particulate mixture into a layered structure configured to define at least a portion of the battery by accelerating the particulate mixture for conformal communication between the particles in the particulate mixture to promote electrochemical charge flow.

2. The method of claim 1 further comprising accelerating the particles by a carrier gas for causing metallurgical contact between the sprayed particles.

3. The method of claim 2 further comprising connecting a pressurized carrier gas supply to a shaped nozzle having a flow directed towards an accumulative layered structure.

4. The method of claim 3 wherein the shaped nozzle has a substantially round cross section with a reduced diameter along a central portion of its length and adapted for converting heat energy of the flow into kinetic energy.

5. The method of claim 1 wherein the active material includes cathode material or anode material for supporting electrochemical charge flow in a battery.

6. The method of claim 2 further comprising spraying the particle mixture based on a set of predetermined parameters for defining a flow rate of the particle mixture, a pressure and temperature of the carrier gas, and a standoff distance of an exit of the nozzle to an accumulative layered structure.

7. The method of claim 5 further comprising spraying the particle mixture onto a conductive planar surface for building the accumulative layered structure.

8. The method of claim 1 wherein agitating includes creating a feedstock having a plurality of agglomerations, each agglomeration including conductive particles and charge material.

9. The method of claim 8 wherein agitating includes creating a feedstock having conductive particles circumferentially surrounded by the charge material particles.

10. The method of claim 6 wherein agitating includes ball milling for generating a uniform mixture of the particles.

11. The method of claim 10 wherein the conductive particles include materials or alloys selected from the group consisting of Al, Cu, Sn, Ta, Co, Ni, Si, V, Ga, Li and C.

12. The method of claim 6 wherein the cathode material includes groups of materials selected from the group consisting of LiNiCoAlO₂ (NCA), LiNiMnCoO₂ (NMC), LiNi₅Co₃Mn₂O₂(Hi-NMC), LiFePO₄ (LFP), LiCoO₂ (LCO), LiMn₂O₄ (LMO), Li₄Ti₅O₁₂ (LTO) or a mixture of cathode materials.

13. The method of claim 6 wherein the anode material includes groups of materials selected from the group consisting of Graphite, Silicon, Li-Sulfur, Lithium metal, tin

14. The method of claim 6 further comprising including a solid electrolyte powder in the agitated particles, and spraying the agitated mixture.

15. The method of claim 1 further comprising forming cathode, electrolyte and anode layers by iteratively spraying additional agitated, particulate mixtures to define a cumulative layered structure having electrical characteristics of the battery.

16. The method of claim 15 further comprising spraying from rows of nozzles defining each of the cathode, electrolyte and anode layers in sequence for a predetermined thickness.

17. The method of claim 16 further comprising generating the particulate mixture in separate hoppers corresponding to each layer of the layered structure.

18. The method of claim 15 further comprising agitating the particles with a liquid for forming agglomerations in the particle mixture, the liquid disintegrating or decomposing prior to deposition. evaporating or disintegrating spray.

19. An apparatus for forming a battery, comprising:
an agitator for agitating particle feedstock to form agglomerations of feedstock for the battery;
a hopper for storing a particulate mixture resulting from agitating the feedstock to form particle agglomerations adapted for conformal contact based on ductility of the agglomerations;
a carrier gas for propelling the particulate mixture through a vessel; and
a shaped nozzle for receiving the propelled, particulate mixture and impelling the particulate mixture for conformal communication between the particles in the particulate mixture to promote charge flow resulting from bombardment of the agglomerated particles.

20. The apparatus of claim 19 wherein the shaped nozzle has a substantially round cross section with a reduced diameter along a central portion of its length and adapted to convert heat energy of the flow into kinetic energy for supersonic bombardment of particles emitted from the shaped nozzle.

21. The method of claim 1 further comprising:
agitating a plurality of particulate mixtures adapted for cold spray deposition, the particulate mixtures including charge material for a battery;
spraying the agitated particulate mixtures into a layered structure configured to define a portion of a battery, each mixture of the plurality of particulate mixtures corresponding to a layer of the battery; and
iteratively spraying additional agitated, particulate mixtures to define a cumulative layered structure having electrochemical characteristics of the battery.

22. The method of claim 21 wherein the particulate mixture is a dry spray particulate mixture, each of the particles configured for adherence to other particles in the absence of a liquid binder.

23. The method of claim 21 wherein the plurality of particulate mixtures include a cathode material, a solid electrolyte material, and an anode material;
spraying the particulate mixtures simultaneously from a succession of nozzles, each nozzle spraying a successive layer in the layered structure; and
advancing a spray receptor surface receptive to the nozzles for receiving each layer of the layered structure, the succession of nozzles defining an ordering of the layers corresponding to finished battery construction.

24. The method of claim 1 wherein agitating further comprises ball milling the particles using a stainless steel ball milling medium in a vertical planetary ball mill.

25. The method of claim 24 wherein the metal binder material is in the range of 19%-22% and the active material is in the range of 68%-80%.

26. The method of claim 24 wherein the active material defined 90% of the agitated particles, the metal binder defined 10% of the agitated particles and a ratio of a ball milling medium to the particles is 12:1.
